(19) United States
(12) Patent Application Publication
(10) Pub. No.: US 2024/0354517 A1
(43) Pub. Date: Oct. 24, 2024

(54) SYSTEMS AND METHODS FOR DETECTING SENSITIVE TEXT IN DOCUMENTS

(71) Applicant: The MITRE Corporation, McLean, VA (US)

(72) Inventors: Luther Karl Branting, Columbia, MD (US); Bradford Clement Brown, Bethesda, MD (US); Kenneth Jeffrey Harrold, Wall Township, NJ (US); Sarah Maureen Howell, Herndon, VA (US); Christopher Mario Giannella, Baltimore, MD (US); James Antony Van Guilder, Bealeton, VA (US)

(73) Assignee: The MITRE Corporation, McLean, VA (US)

(21) Appl. No.: 18/640,717

(22) Filed: Apr. 19, 2024

Related U.S. Application Data
(60) Provisional application No. 63/461,102, filed on Apr. 21, 2023.

(51) Int. Cl. G06F 40/40; G06F 16/93; G06F 40/205; G06F 40/279; G06V 30/414

(52) U.S. Cl. CPC G06F 40/40; G06F 40/205; G06F 40/279; G06V 30/414; G06F 16/93

(57) ABSTRACT

A method for providing suggested text redactions for a document, includes receiving, from a user, the document comprising text; extracting the text from the document; parsing the extracted text into a plurality of identified text sentences; inputting the plurality of identified text sentences into one or more trained artificial intelligence models that have been trained on labeled text sentences to generate a set of suggested text redactions for the plurality of identified text sentences; and providing the set of suggested text redactions for the plurality of identified text sentences to the user.

### CROSS-REFERENCE TO RELATED APPLICATIONS

This application claims the benefit of U.S. Provisional Application No. 63/461,102, filed Apr. 21, 2023, the entire contents of which is incorporated herein by reference.

### FIELD

This disclosure generally relates to text classification, and more specifically to artificial intelligence assisted detection of sensitive text in documents.

### BACKGROUND

Transparency is vital for representative democracy. Freedom of information laws (e.g., the Freedom of Information Act (FOIA)) allow citizens to obtain government documents in order to gain transparency into certain government functions. However, exemptions to disclosure are necessary to protect privacy and to permit government officials to deliberate freely. As a result, some documents or portions thereof must be redacted before they can be provided to a requestor.

Responding to requests under FOIA may burden agency personnel with the tedious and error-prone task of manual identification and redaction of exempt text. The burden for government agencies of compliance with open-records requirements can lead to frustrations and delays for requestors.

Computer programs may be used to identify and redact exempt text. However, existing programs are deficient because they fail to accurately identify certain types of exempt text. For example, identification of deliberative text is particularly challenging. Deliberative text is text that is covered by the deliberative process privilege, which protects pre-decisional materials (e.g., advisory opinions, recommendations, proposals, suggestions, and deliberations) generated as part of the decision-making process in federal agencies. Furthermore, existing programs lack functionality for users to interact with the text (e.g., to view, accept, or reject suggested redactions).

### SUMMARY

Described herein are systems and methods for detecting sensitive text in documents to provide decision support to FOIA analysts using one or more artificial intelligence (AI) models. A user may provide a document from which text may be extracted. The text can be parsed into a plurality of identified text sentences. The plurality of identified text sentences may then be provided to one or more trained AI models. The AI models may be capable of identifying text subject to a FOIA exemption, including deliberative text, at sentence-level granularity. The AI models may be trained on a data set of text sentences labeled based on whether each text sentence includes deliberative language and, thus, whether the sentence should be redacted. The training data set may be annotated by nationally recognized FOIA experts, thereby aligning the output of the trained AI models with the judgment of subject matter experts. The trained AI models may generate a set of suggested text redactions for the plurality of identified text sentences, which may be provided to a user.

The set of suggested text redactions generated by the trained AI models may be provided to a user via a graphical user interface. The graphical user interface may be configured to allow the user to interact with the text and the corresponding suggested text redactions. For instance, the user can view redaction suggestions generated by the trained AI models and accept or reject the suggestions. The graphical user interface may also be configured to allow a user to implement custom redactions or redaction patterns.

By providing FOIA analysts with suggested text redactions that were located automatically by the trained AI models, the systems and methods described herein may promote consistency across analysts and agencies. Furthermore, the systems and methods described herein may reduce the cognitive load of FOIA analysts by eliminating the need to search for and select each and every passage in a document requiring redaction.

A method for providing suggested text redactions for a document can include receiving, from a user, the document comprising text; extracting the text from the document; parsing the extracted text into a plurality of identified text sentences; inputting the plurality of identified text sentences into one or more trained artificial intelligence models that have been trained on labeled text sentences to generate a set of suggested text redactions for the plurality of identified text sentences; and providing the set of suggested text redactions for the plurality of identified text sentences to the user.

The document may be a Portable Document Format (PDF) document, a plain text document (TXT), a Joint Photographic Experts Group (JPEG) document, or a Portable Network Graphics (PNG) document. Extracting the text may comprise identifying one or more text-based sections of the document from a plurality of sections of the document. Extracting the text may comprise computing a visual position and size for a plurality of text characters of the text. Parsing the extracted text may comprise identifying visual boundaries for a plurality of graphic representations of text characters and assembling the plurality of graphic representations of text characters into one or more groups. Parsing the extracted text may include grouping the extracted text into the plurality of identified text sentences. The one or more trained artificial intelligence models may comprise a trained language model. The set of suggested text redactions may be displayed on a representation of the document. The set of suggested text redactions may correspond to whether each of the plurality of identified sentences is associated with one or more predefined categories of information for redaction. The one or more predefined categories of information may comprise deliberative language. Prior to inputting the plurality of identified text sentences into the one or more trained artificial intelligence models, a set of features associated with the plurality of identified text sentences may be determined, wherein the set of features are inputted into the one or more trained artificial intelligence models.

A system for providing suggested text redactions for a document can include one or more processors and a memory coupled to the processors comprising instructions executable by the processors, the processors being operable when executing the instructions to cause the system to receive, from a user, the document comprising text; extract the text from the document; parse the extracted text into a plurality of identified text sentences; input the plurality of identified text sentences into one or more trained artificial intelligence models that have been trained on labeled text sentences to generate a set of suggested text redactions for the plurality of identified text sentences; and provide the set of suggested text redactions for the plurality of identified text sentences to the user.

A non-transitory computer-readable storage medium storing instructions that, when executed by one or more processors of an electronic device, may cause the device to receive, from a user, the document comprising text; extract the text from the document; parse the extracted text into a plurality of identified text sentences; input the plurality of identified text sentences into one or more trained artificial intelligence models that have been trained on labeled text sentences to generate a set of suggested text redactions for the plurality of identified text sentences; and provide the set of suggested text redactions for the plurality of identified text sentences to the user.

A method for providing suggested text redactions for a document can include displaying a graphical user interface comprising a text region comprising a visual representation of a document comprising text, and a menu region comprising a first set of suggested text redactions corresponding to the document comprising text and a first set of interactive graphical user interface menu objects configured to receive user inputs corresponding to the first set of suggested text redactions, wherein the first set of suggested text redactions is generated by one or more artificial intelligence models that have been trained on labeled text sentences; receiving a first user input comprising user interaction with a first menu object of the first set of menu objects, wherein the first user input indicates an instruction corresponding to a suggested text redaction; and updating display of the text region in accordance with the first user input in response to receiving the first user input. The first user input may indicate acceptance of a suggested text redaction of the first set of suggested text redactions. The first user input may indicate rejection of a suggested text redaction of the first set of suggested text redactions.

The menu region may include an interactive graphical user interface menu option configured to receive user-specified text redaction patterns. The method can further include receiving a second user input comprising user interaction with the menu option, wherein the second user input indicates a user-specified text redaction pattern; and in response to receiving the second user input, generating a second set of suggested text redactions corresponding to the user-specified text redaction pattern. The menu region may include a second set of interactive graphical user interface menu objects configured to receive user inputs corresponding to the second set of suggested text redactions. The method can further include receiving a third user input comprising user interaction with a second menu object of the second set of menu objects, wherein the third user input indicates an instruction corresponding to a suggested text redaction; and in response to receiving the third user input, updating display of the text region in accordance with the third user input. The third user input may indicate acceptance of a suggested text redaction of the second set of suggested text redactions. The third user input may indicate rejection of a suggested text redaction of the second set of suggested text redactions.

The method can further include receiving a fourth user input comprising user interaction with one or more portions of the visual representation of the document, wherein the fourth user input indicates one or more portions of the document to redact; and in response to receiving the fourth user input, updating display of the text region to redact the one or more portions of the document corresponding to the fourth user input.

### BRIEF DESCRIPTION OF THE DRAWINGS

FIG. 1 illustrates a method for providing suggested text redactions for a document.

FIG. 2 illustrates an example user interface to allow users to interact with the FOIA

### Assistant.

FIG. 3 illustrates an example menu to accept or reject a specific redaction suggestion.

FIG. 4 illustrates a user interface that lists all of the redaction suggestions.

FIG. 5 illustrates a user interface to create an ad hoc redaction.

FIG. 6 illustrates an example of a released file with redactions.

FIG. 7 illustrates a system architecture for an example implementation of the FOIA

### Assistant.

FIG. 8 illustrates an example result of converting PDF input into glyphs.

FIG. 9 illustrates an example of text segments in a PDF document.

FIG. 10 illustrates the results of an initial line-based resegmentation.

FIG. 11 illustrates an example computer system.

FIG. 12 illustrates a user interface configured to create custom rules.

FIG. 13 illustrates a user interface configured to display custom rules.

FIG. 14 illustrates a user interface configured to display redaction suggestions based on custom rules.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer-readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FGPAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the present disclosure as described herein.

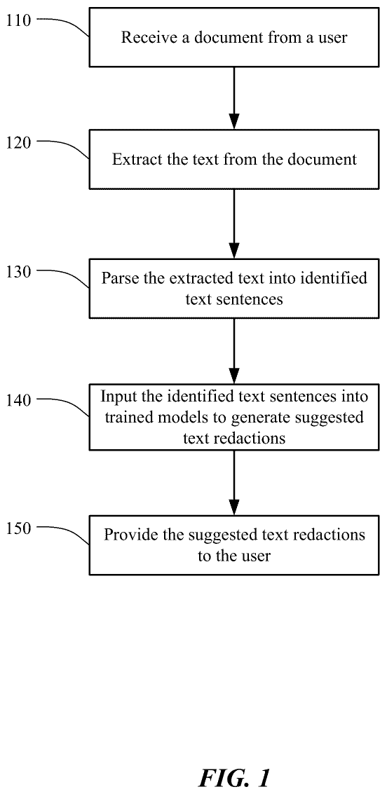

FIG. 1 illustrates a method 100 for providing suggested text redactions for a document. The method 100 may be performed by an application on any computing system. In various embodiments, the application may be directed to assisting various users (such as analysts, subject matter experts (SMEs), or an agency's personnel) in complying with the US Freedom of Information Act (FOIA) and may be referenced herein as the FOIA Assistant. In various embodiments, the FOIA Assistant may be implemented as a desktop application and/or as part of a client-server architecture (e.g., as a web application).

The method 100 may begin at step 110 where the FOIA Assistant may receive a document from a user. The document may be any type of document, such as a Portable Document Format (PDF), and may include text in a specific format that corresponds to the document, such as an internal PDF format. Other suitable document types include plain text (TXT) documents, Joint Photographic Experts Group (JPEG) documents, or Portable Network Graphics (PNG) documents. Various sections of the document's text may need to be redacted before the document is released in accordance with FOIA. The FOIA Assistant may also receive other types of files from a user, such as audio files. If a file other than a document is received, the FOIA Assistant may obtain a text representation of the file (e.g., an audio transcript) to redact.

At step 120, the FOIA Assistant may extract the text from the document. The specific extraction process may depend on the type of document received from the user. For example, extracting the text from a Portable Document Format (PDF) document may include reading text information from an internal document format and converting to a more standard text format, such as a Unicode representation. At step 130, the FOIA Assistant may parse the extracted text into identified text sentences. This may include parsing the extracted text into sentences so that the text may be inputted into the trained AI models of the FOIA Assistant. As a running example, the FOIA Assistant desktop application reads an original PDF document and performs text extraction, including calculating position and size information for each character extracted from the document. A simplified JSON representation of the document, containing only the extracted text, is sent to the FOIA Exemption suggestion service.

At step 140, the FOIA Assistant may input the identified text sentences to one or more trained artificial intelligence (AI) models to generate suggested text redactions for the document. The suggested text redactions outputted from the AI models may include a suggestion on whether to redact each of the identified text sentences. Using the running example, the FOIA Exemption suggestion service uses a variety of techniques, including artificial intelligence models, to annotate the text and return a richly annotated form of the document.

Training the AI models to be able to operate at a sentence-level granularity may differ from training models that operate at a coarser granularity, such as paragraph-level granularity. A training set with labels for whether paragraphs can be exempt under FOIA may include assigning to each paragraph one of four labels: D1, for paragraphs exempt because they are within the scope of the deliberative process privilege; E0, for paragraphs non-exempt because they occur in documents that are not between members of the executive branch (i.e., not “intra/inter-agency”); T0, for trivially non-exempt paragraphs (e.g. file header information); and D0, for all other non-exempt paragraphs. Assuming T0 and E0 are ignored for a lack of utility in training a content-based classifier, the resulting corpus of paragraphs labeled as D1 or D0 may be valuable but has at least two limitations that complicate its use in building accurate artificial intelligence models (e.g., classifiers). First, some paragraphs labeled D1 do not contain any sentences that are deliberative per se, irrespective of context, such as recommendations, opinions, suppositions, or options. Instead, the D1 annotation of such paragraphs is justified by the larger context of the document in which the paragraphs appear. For example, paragraphs in an enumeration that starts “The president could:” fall into this category because this opening justifies a D1 label on all of the subsequent paragraphs in the enumeration regardless of their content. Second, some of the paragraphs labeled D0 contain sentences that are deliberative in themselves but did not fall within the scope of the deliberative process privilege because they occur in documents that were not between members of the Executive branch, (i.e., they are not “intra/inter-agency”). An annotated set consisting of individual sentences labeled D1 or D0 according to the paragraphs in which they appear is therefore of only limited utility for training a sentence-level classifier because the label of many sentences depends on factors outside of the text of the sentence itself (i.e., the surrounding context or whether the sender and intended recipient are both in an Executive agency).

In view of the limitations of the paragraph-level labeling of training data, labeling of training data according to the principles described herein are directed to making detection of deliberative language a tractable text classification task. According to various examples, a training data annotation scheme labels individual sentences as deliberative or non-deliberative based on their individual structure and content, i.e., characteristics amenable to computational analysis. Specifically, in some examples, labeling of training data includes identifying sentences whose deliberative character depends neither on the broader context in which the sentence occurs (the first limitation above) nor on the nature of the sender or recipient, i.e., whether either is an attorney or is outside of any executive agency (the second limitation). The label for such sentences in the present disclosure is “AD,” meaning “Always Deliberative.”

It may be noted that paragraphs labeled as D1 may contain at least one sentence that was deliberative in isolation. This excludes the conceptually difficult case of a deliberative paragraph that consisted exclusively of non-deliberative sentences. It also suggests that by finding every deliberative sentence, the FOIA Assistant will, a fortiori, find every deliberative paragraph.

The assignment of the labels “AD” and “Non-AD” to artificial intelligence model training data can be conceptualized in two steps. The first step focuses on the sentences in paragraphs labeled D1 (i.e., paragraphs subject to the deliberative language exemption). Each sentence occurring in a D1 paragraph was labeled “AD” if its text was deliberative in isolation, irrespective of context, and otherwise labeled “Non-AD.”

The second step of labeling the training data concerns sentences in D0 paragraphs, which may be paragraphs labeled as non-exempt. Some of these paragraphs occurred in communications within or between federal agencies, i.e., they were “Intra/Inter-Agency” (IIA). Sentences in these paragraphs were labeled “Non-AD” because the paragraphs themselves must have been labeled D0 because they are non-deliberative rather than because they were not IIA communications.

In summary, a new set of annotations at the sentence level may be created that corresponds to the task for the FOIA Assistant to perform: identifying individual deliberative sentences. This labeling of training data can be used to build a classifier that, given the text of a sentence, predicts whether the sentence should have an AD or Non-AD (i.e., always deliberative vs. deliberative only in certain contexts, if at all) label.

Various artificial intelligence model architectures, trained with training data labeled as described above, may be used to generate the suggested text redactions. Two examples of models that may be used are a Support Vector Machine (SVM) and a Logistic Regression (LR) classifier using simple word-count based features. The feature spaces for an SVM and LR model may also be modified as described further below.

On modifying the feature spaces for an SVM and LR model, first, the simple word count features using the spaCy named entity recognizer may be modified. Before counts are computed, words in text that are part of a named entity may be mapped to strings “<ET>” where ET denotes the name of the entity type, e.g., “<PERSON>.” Additional features may be added (e.g., each computed at the sentence-level): the number of modal words (e.g., could, would, etc.), adverbs, adjectives, nouns, comparators (adverbs ending in-er), progressive aspect verbs, perfect aspect verbs, past tense verbs, present tense verbs, first person pronoun subjects, strongly subjective words, and/or an indicator based on an overall sentence subjectivity classification. The first ten of these may be calculated from an application of spaCy to the sentence. The eleventh feature may be calculated using a system (such as Sentiwordnet) that assigns a subjectivity score between zero and one to pairs of words and their part-of-speech-tags. The last feature may be a corpus of sentences with manually assigned “subjective” or “objective” labels.

In some embodiments, a classifier may operate directly on sentence text without requiring the manual specification of domain-specific features. An exemplary classifier may use the Bidirectional Encoder Representations from Transformers (BERT) framework. A logistic regression layer with dropout may be added on top of the pooled output from a BERT model. The BERT model may be optimized by fine-tuning with bias correction and a small learning rate (e.g., 2e-5). Training may be performed over multiple epochs (e.g., 20). The learning rate may be linearly increased for a first portion of steps (e.g., 10%) and linearly decayed to zero afterward. The dropout may be maintained at 0.1. The resulting classifier may be implemented in Python using the Keras interface and the “small bert,” uncased, L-2, H-512, A-8 transformer model.

Referring back to method 100, at step 150, the FOIA Assistant may provide the suggested text redactions to the user that originally provided the document. The suggested redactions may be provided in various ways to the user depending on the implementation. In the running example, the FOIA Assistant uses the resultant annotated form of the document to display suggestions for redaction to the analyst on a rendering of the original PDF document.

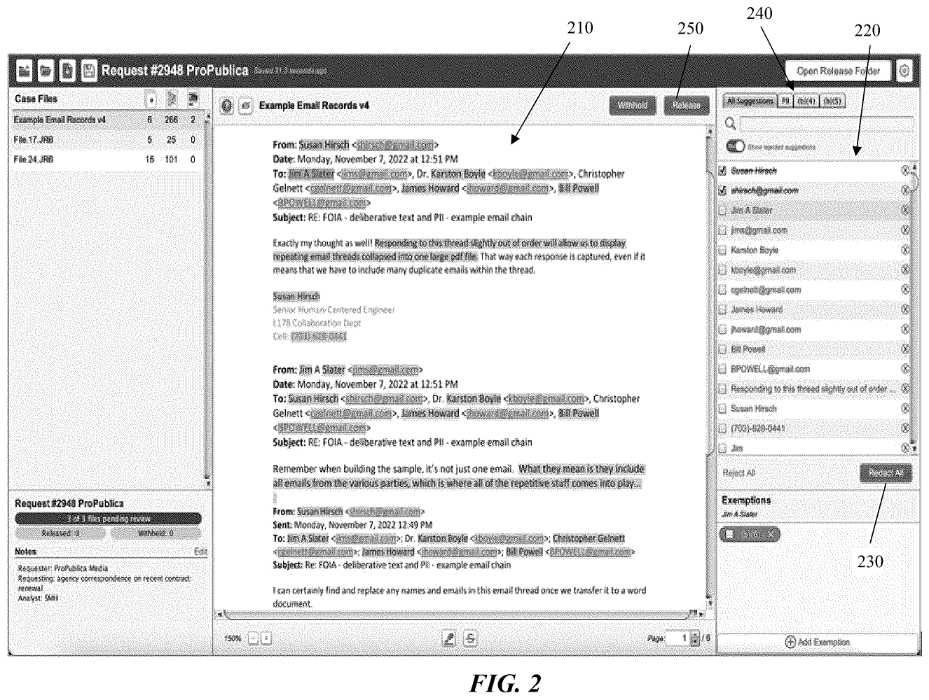

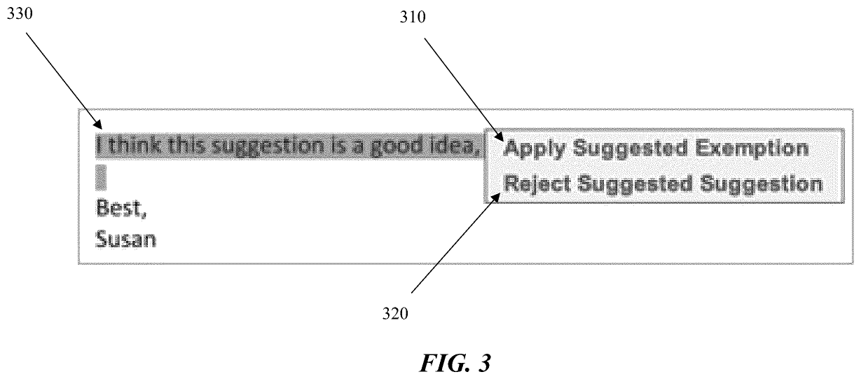

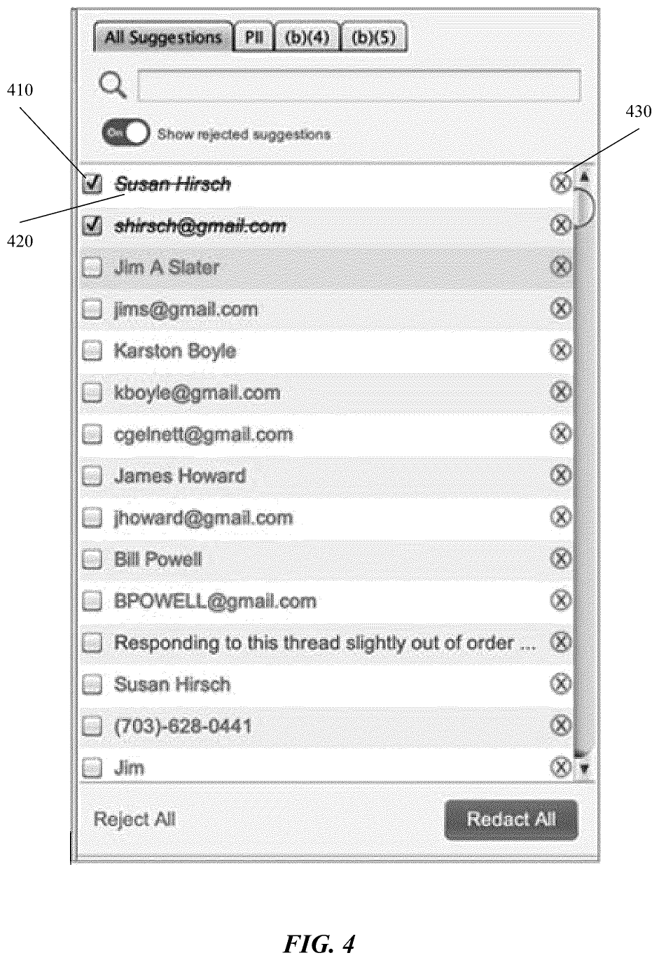

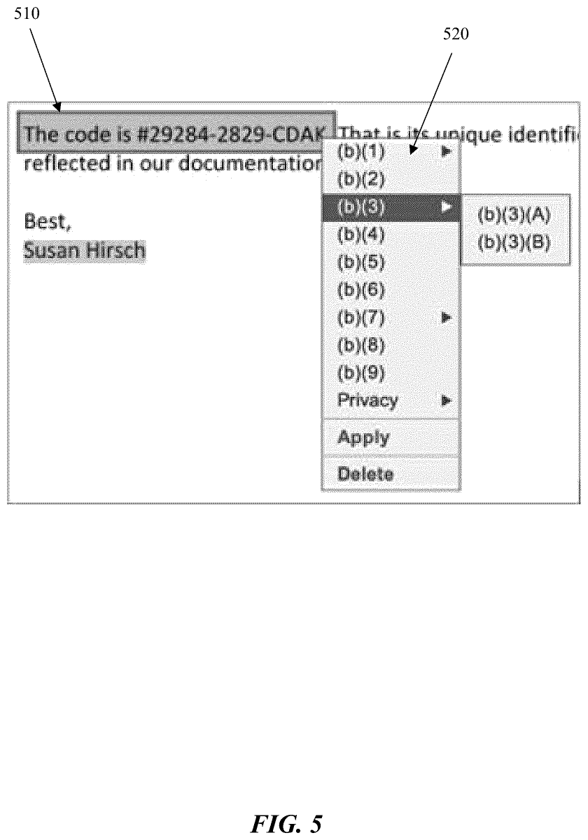

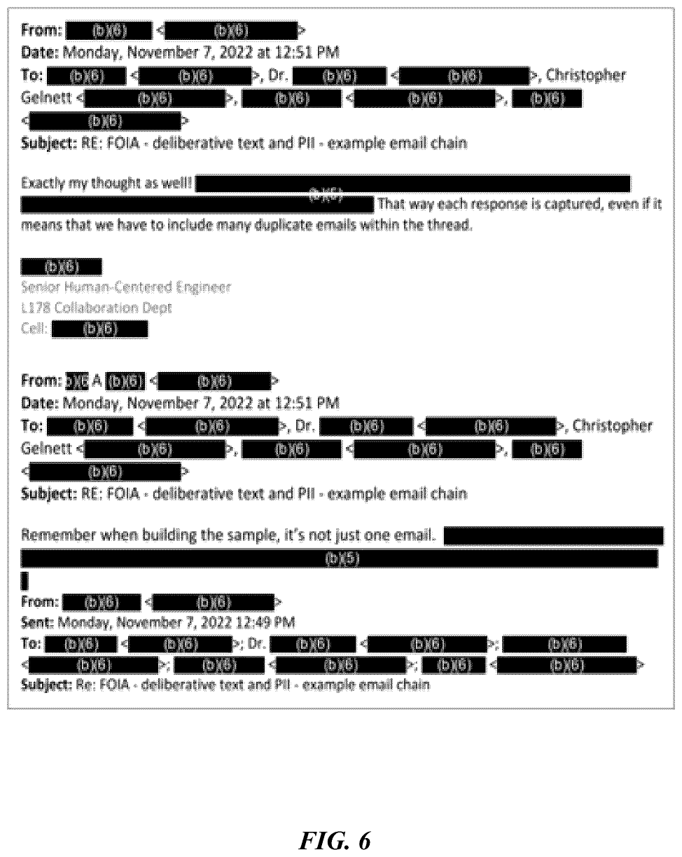

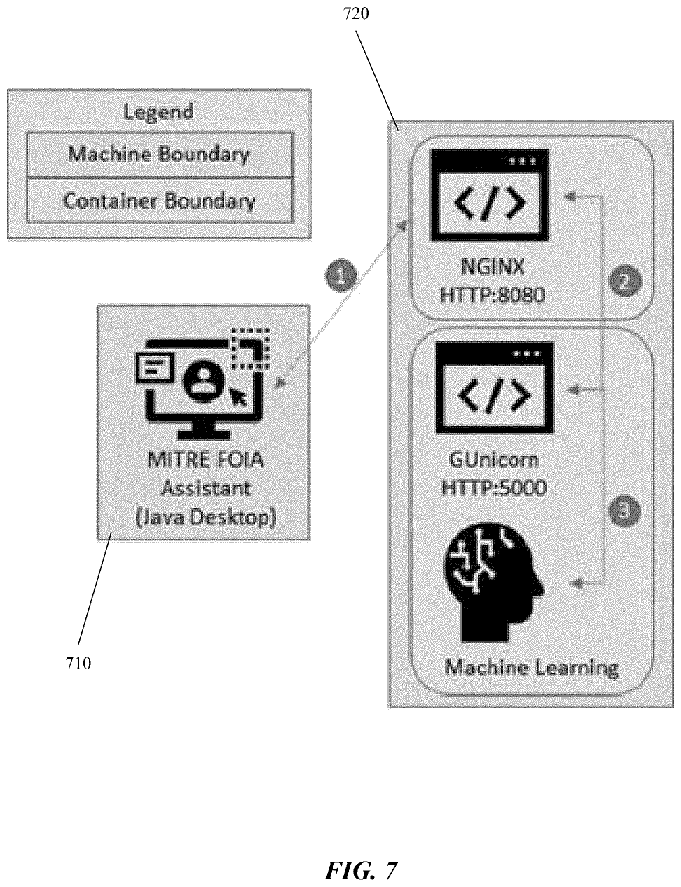

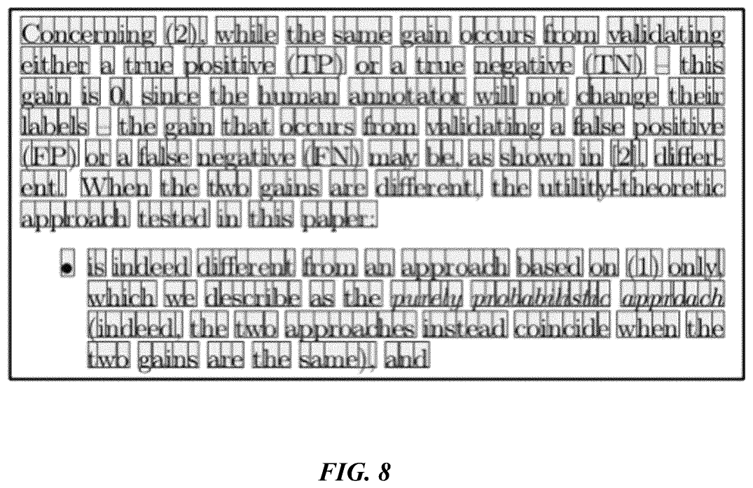

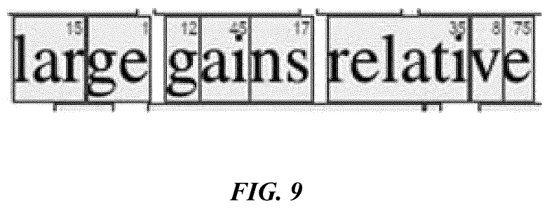

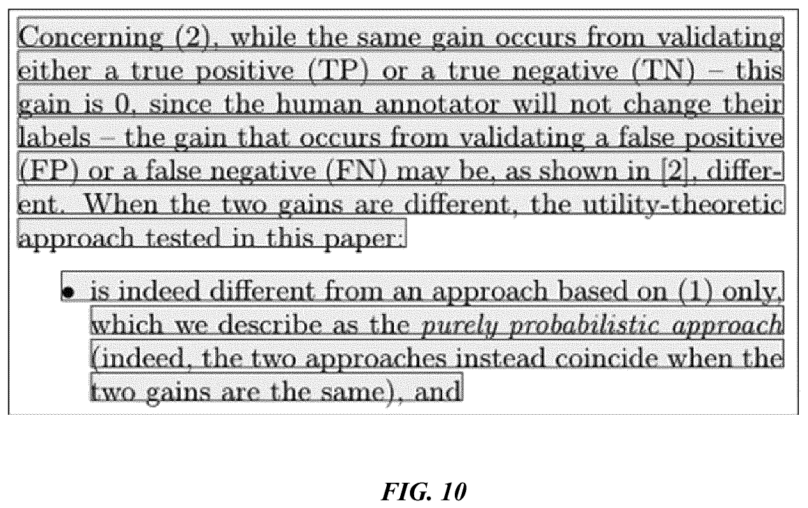

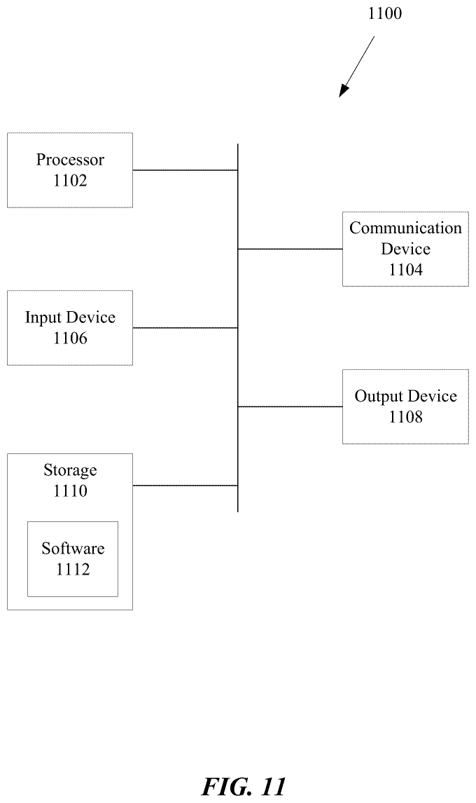

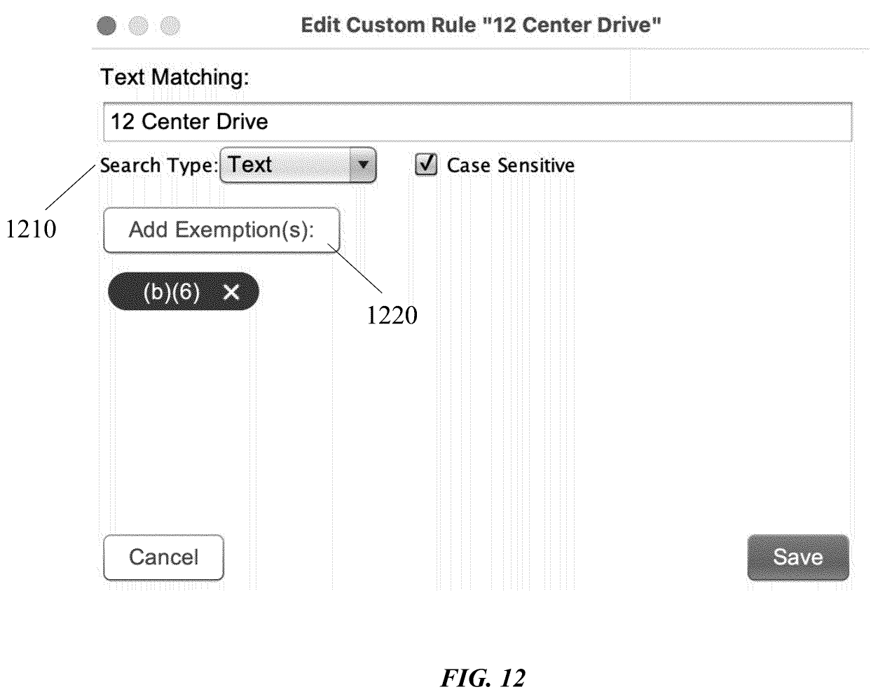

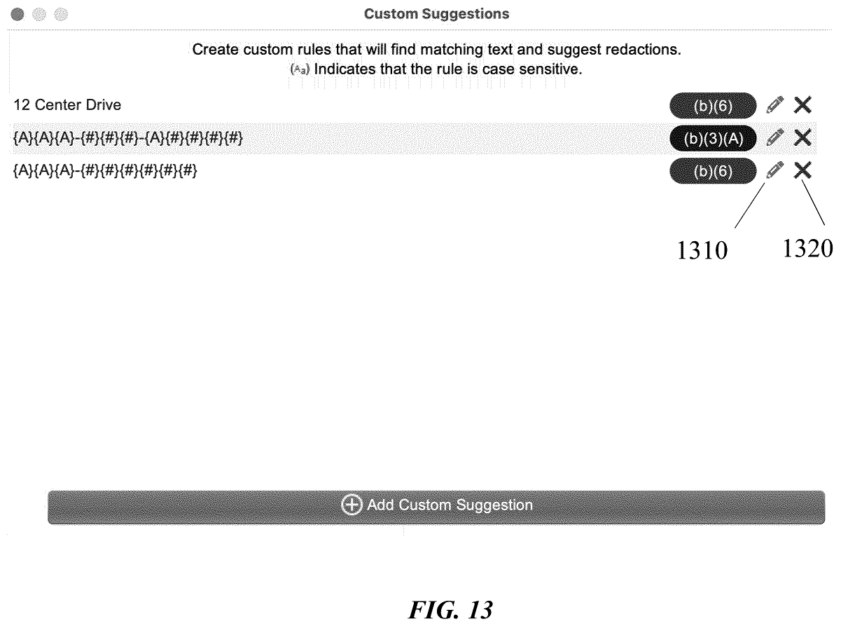

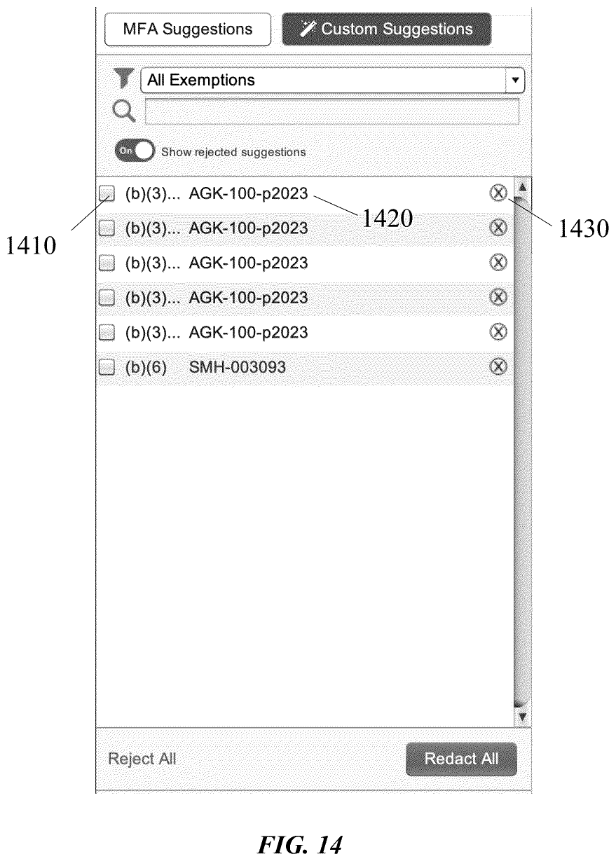

FIG. 2 illustrates an example user interface to allow users to interact with the FOIA Assistant. Users may interact with the user interface through three panels. The left panel displays the case (which corresponds to an individual FOIA request) currently under review by the user and, for each document in the case, the number of pages, suggestions (i.e., passages flagged as potentially exempt and pending review by the user), and redactions (i.e., suggestions that have been accepted and ad hoc redactions applied manually by the user) in that document. The middle panel displays the text of the document with suggestions highlighted in colors that indicate the type of sensitive information, e.g., red for PII, blue for deliberative language, and green for dollar amounts (which can be sensitive under Exemption 4 of FOIA, which covers privileged commercial or financial information). These suggestions are intended to be reviewed and accepted by the user before any redaction is performed in the released file; analysts are free to accept, reject, or ignore any suggestion. If the user ignores or rejects a suggested redaction, the text segment may not be redacted in the released file.

The interface presents multiple affordances for an analyst to accept or reject suggestions, depending on the analyst's preferences. Analysts can review the text in the middle panel 210 and select any highlighted region. A right click displays a menu to accept 310 or reject 320 that specific suggestion (FIG. 3), or the user can use the Spacebar key as a shortcut for accepting the current suggestion 330. Alternatively, users can refer to the right panel 220, which lists all of the suggestions, each with a corresponding checkbox 410 (FIG. 4). Selecting the checkbox accepts the suggestion and applies the corresponding exemption code and redaction 420. Clicking the X 430 to the right of the text rejects the suggestion, removing the highlighted region from the document panel.

Using the Redact All feature 230 in conjunction with the available filters 240 enables users to rapidly apply redactions to repeated text, such as PII. The suggestion panel 220 provides filtered views of the suggestions, permitting the analyst to view lists of suggestions associated with each exemption type. An analyst can perform a keyword search to reduce the displayed list to only matching results. Clicking Redact All 230 accepts every suggested redaction displayed in the list.

If an analyst wishes to redact a passage under an exemption not currently implemented by the user interface (i.e., an exemption other than 4, 5, 6, or 7 (c) of FOIA, which may be the only exemptions supported at a given point in time) or redact text not suggested for redaction by the FOIA Assistant's currently implemented models (i.e., because of a false negative by one of the models), the analyst can create an ad hoc redaction. The ad hoc redaction tool, shown in FIG. 5, enables the user to draw a box 510 around any desired content for selection and redaction under any appropriate FOIA exemption or Privacy Act exemption 520. Once the file has been reviewed and all necessary redactions applied, the analyst can release the file by clicking Release 250 at the upper right of the middle panel (see FIG. 2). The user interface also provides the option to withhold a file in full if necessary. Releasing or withholding a file will update the Case Files table, marking them accordingly (R for released files, W for withheld files). Files selected to be withheld are withheld in full and therefore do not require an alternate redacted version to be created. If a file is released with redactions applied, a new PDF file is generated. To access the released version of the file, the user could double click on the file name in the Case Files list or access the folder in their directory by clicking Open Release Folder. FIG. 6 shows an example of a released file with redactions.

Additionally, if a user wishes to redact a passage under an exemption not currently implemented by the user interface or redact text not suggested for redaction by the FOIA Assistant's currently implemented models, the user can create a custom rule. The user interface may be configured to allow a user to create a custom rule by specifying a pattern to redact in the text of a document. The pattern may be specified as raw text, a wildcard, or a regular expression. The pattern may correspond to personal identifying information (PII), contract numbers, or other information covered by an exemption that follows a specific format or pattern. A user may also specify, for each pattern, a corresponding exemption. For example, as shown in FIG. 12, a user may select the type of pattern 1210 for which to search in the document. The user can also specify an appropriate exemption (e.g., a FOIA exemption or a Privacy Act exemption) that corresponds to the pattern by selecting Add Exemption(s) 1220. The user can manually specify an exemption, or the FOIA Assistant can suggest an exemption that may correspond to the pattern. The custom rule can then be saved in a list of custom rules, as shown in FIG. 13. The list of custom rules may be a set of agency-specific rules. Custom rules may be edited by selecting the editor icon 1310 or removed by selecting the X 1320.

As discussed above with reference to FIG. 2, the user interface may be configured to display a panel alongside the text of the document (e.g., right panel 220 shown in FIG. 2) that allows a user to accept or reject suggested redactions. The panel may display suggested redactions corresponding to custom rules, as shown in FIG. 14. Each suggested redaction may have a corresponding checkbox 1410. A user can accept a suggestion by selecting the checkbox, which applies the corresponding exemption and redaction 1420 to the document. A user can reject a suggestion by selecting the X 1430, which removes the corresponding suggested redaction 1420 from the document.

FIG. 7 illustrates a system architecture for an example implementation of the FOIA Assistant. The FOIA Assistant is implemented in the client-server architecture depicted in FIG. 7. The Java Desktop application 710 interacts with the file system (ingesting PDF documents, extracting text, and writing the annotated and redacted versions of document), invokes the backend service 720 to obtain suggestions from the machine-learning models, and implements the user interface functionality described above. The server centralizes the machine-learning models. The client sends documents to the server in batches of a predetermined number of documents at a time to permit analysts to start working on documents with suggestions without having to wait for the full set of documents to be processed. The server has a modular design that can accommodate additional models to enable the FOIA Assistant to be customized to agencies needing other suggestion services.

As described above with respect to FIG. 1, the FOIA Assistant may extract text from a document as part of generating suggested redactions for that document. The accuracy of the models for detecting various categories of exempt information, such as deliberative language and Personally Identifiable Information (PII), depends on accurate extraction of text from the native document format. It is particularly important to recover the sentence order of words in the document, both because the models, such as a deliberative language model, classify text at the sentence level and because various tools applied in conjunction with the models, such as the spaCy's NER model, depends on an accurate sequential context for segmentation (determining the span of an entity) and labeling (the label of a given span may depend on the labels of nearby spans).

As also mentioned above, the FOIA Assistant may be applied to generated suggested text redactions for various document types, such as PDF documents. Extraction of text from a PDF document to accurately recover word order is challenging due to the nature of the representation of the text within the PDF document and the fact that PDF representations can come in several internal formats.

The first step performed by the text extractor is reading the internal format of the PDF document and identifying segments of the document that are text-based. Each text character on the screen is represented as a glyph within an embedded font. The embedded font information is used to map each glyph to its equivalent Unicode representation while maintaining its visual boundary information. Text characters are often represented in groups within the document, although these groups are not based on text constructs such as words, phrases, or sentences. For known glyphs without a valid Unicode mapping, OCR is used, per-character, to attempt to determine the Unicode character that is being represented by the glyph. The result of converting PDF input into glyphs is illustrated in FIG. 8.

Once the segment and glyph boundaries are extracted, the next step is assembling the independent text snippets into groups useful for text analytics. As illustrated by the PDF fragment shown in FIG. 9, the text segments within the PDF document are not in general represented in the way a text-based representation would group them. The segments are often only a few characters long and do not represent words, phrases, or sentences. The red numbers in the top right of each of the segments in FIG. 9 represent their order in the underlying PDF, showing that the segments are not in general sequenced in top-down, left-to-right order. Instead, the grouping and ordering of the characters within the PDF is based on such factors as optimizing the rendering or editing of the document. Note that whitespace between the characters is often not represented by the PDF document (because representing and rendering whitespace takes space and time and often does not affect the visual display). The text extraction process groups the characters into segments on visual “lines” based on the glyph/segment rotations and boundaries. This involves potentially rotating, grouping, and comparing boundary proximities and overlaps. The spacing between words is inferred based on heuristics of presumed space sizes for the glyphs as they are assembled. FIG. 10 shows the results of the initial line-based resegmentation.

FIG. 11 illustrates an example of a computing system 1100, in accordance with one or more examples of the disclosure. Computing system 1100 can be a computer connected to a network. Computing system 1100 can be a client computer or a server. As shown in FIG. 11, computing system 1100 can be any suitable type of microprocessor-based device, such as a personal computer, workstation, server, or handheld computing device (portable electronic device) such as a phone or tablet, or dedicated device. The computing system can include, for example, one or more of processors 1102, input device 1106, output device 1108, storage 1110, and communication device 1104. Input device 1106 and output device 1108 can generally correspond to those described above and can either be connectable or integrated with the computer.

Input device 1106 can be any suitable device that provides input, such as a touch screen, keyboard or keypad, mouse, or voice-recognition device. Output device 1108 can be any suitable device that provides output, such as a touch screen, haptics device, or speaker.

Storage 1110 can be any suitable device that provides storage, such as an electrical, magnetic, or optical memory, including a RAM, cache, hard drive, removable storage disk, or other non-transitory computer readable medium. Communication device 1104 can include any suitable device capable of transmitting and receiving signals over a network, such as a network interface chip or device. The components of the computing system can be connected in any suitable manner, such as via a physical bus or wirelessly.

Processor(s) 1102 can be any suitable processor or combination of processors, including any of, or any combination of, a central processing unit (CPU), field programmable gate array (FPGA), and application-specific integrated circuit (ASIC). Software 1112, which can be stored in storage 1110 and executed by processor 1102, can include, for example, the programming that embodies the functionality of the present disclosure (e.g., as embodied in the devices as described above).

Software 1112 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1110, that can contain or store programming for use by or in connection with an instruction execution system, apparatus, or device.

Software 1112 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computing system 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computing system 1100 can implement any operating system suitable for operating on the network. Software 1112 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method for providing suggested text redactions for a document, comprising:
receiving, from a user, the document comprising text;
extracting the text from the document;
parsing the extracted text into a plurality of identified text sentences;
inputting the plurality of identified text sentences into one or more trained artificial intelligence models that have been trained on labeled text sentences to generate a set of suggested text redactions for the plurality of identified text sentences; and
providing the set of suggested text redactions for the plurality of identified text sentences to the user.

2. The method of claim 1, wherein the document is a Portable Document Format (PDF) document, a plain text (TXT) document, a Joint Photographic Experts Group (JPEG) document, or a Portable Network Graphics (PNG) document.

3. The method of claim 1, wherein extracting the text comprises identifying one or more text-based sections of the document from a plurality of sections of the document.

4. The method of claim 1, wherein extracting the text comprises computing a visual position and size for a plurality of text characters of the text.

5. The method of claim 1, wherein parsing the extracted text comprises identifying visual boundaries for a plurality of graphic representations of text characters and assembling the plurality of graphic representations of text characters into one or more groups.

6. The method of claim 1, wherein parsing the extracted text comprises grouping the extracted text into the plurality of identified text sentences.

7. The method of claim 1, wherein the one or more trained artificial intelligence models comprise a trained language model.

8. The method of claim 1, wherein the set of suggested text redactions is displayed on a representation of the document.

9. The method of claim 1, wherein the set of suggested text redactions corresponds to whether each of the plurality of identified sentences is associated with one or more predefined categories of information for redaction.

10. The method of claim 9, wherein the one or more predefined categories of information comprises deliberative language.

11. The method of claim 1, further comprising:
prior to inputting the plurality of identified text sentences into the one or more trained artificial intelligence models, determining a set of features associated with the plurality of identified text sentences, wherein the set of features are inputted into the one or more trained artificial intelligence models.

12. A system for providing suggested text redactions for a document, comprising one or more processors and a memory coupled to the processors comprising instructions executable by the processors, the processors being operable when executing the instructions to cause the system to perform a method comprising:
receiving, from a user, the document comprising text;
extracting the text from the document;
parsing the extracted text into a plurality of text sentences;
inputting the plurality of text sentences into one or more trained artificial intelligence models that have been trained on labeled text sentences to generate a set of suggested text redactions for the plurality of identified text sentences; and
providing the set of suggested text redactions for the plurality of identified text sentences to the user.

13. A non-transitory computer-readable storage medium storing instructions that, when executed by one or more processors of an electronic device, cause the device to perform a method comprising:
receiving, from a user, the document comprising text;
extracting the text from the document;
parsing the extracted text into a plurality of text sentences;
inputting the plurality of text sentences into one or more trained artificial intelligence models that have been trained on labeled text sentences to generate a set of suggested text redactions for the plurality of identified text sentences; and
providing the set of suggested text redactions for the plurality of identified text sentences to the user.

14. A method for providing suggested text redactions for a document, comprising:
displaying a graphical user interface comprising a text region comprising a visual representation of a document comprising text, and a menu region comprising a first set of suggested text redactions corresponding to the document comprising text and a first set of interactive graphical user interface menu objects configured to receive user inputs corresponding to the first set of suggested text redactions, wherein the first set of suggested text redactions is generated by one or more artificial intelligence models that have been trained on labeled text sentences;
receiving a first user input comprising user interaction with a first menu object of the first set of menu objects, wherein the first user input indicates an instruction corresponding to a suggested text redaction; and
updating display of the text region in accordance with the first user input in response to receiving the first user input.

15. The method of claim 14, wherein the first user input indicates acceptance of a suggested text redaction of the first set of suggested text redactions.

16. The method of claim 14, wherein the first user input indicates rejection of a suggested text redaction of the first set of suggested text redactions.

17. The method of claim 14, wherein the menu region comprises an interactive graphical user interface menu option configured to receive user-specified text redaction patterns.

18. The method of claim 17, comprising:
receiving a second user input comprising user interaction with the menu option, wherein the second user input indicates a user-specified text redaction pattern; and
in response to receiving the second user input, generating a second set of suggested text redactions corresponding to the user-specified text redaction pattern.

19. The method of claim 18, wherein the menu region comprises a second set of interactive graphical user interface menu objects configured to receive user inputs corresponding to the second set of suggested text redactions.

20. The method of claim 19, comprising:
receiving a third user input comprising user interaction with a second menu object of the second set of menu objects, wherein the third user input indicates an instruction corresponding to a suggested text redaction; and
in response to receiving the third user input, updating display of the text region in accordance with the third user input.

21. The method of claim 20, wherein the third user input indicates acceptance of a suggested text redaction of the second set of suggested text redactions.

22. The method of claim 20, wherein the third user input indicates rejection of a suggested text redaction of the second set of suggested text redactions.

23. The method of claim 14, comprising:
receiving a fourth user input comprising user interaction with one or more portions of the visual representation of the document, wherein the fourth user input indicates one or more portions of the document to redact; and
in response to receiving the fourth user input, updating display of the text region to redact the one or more portions of the document corresponding to the fourth user input.
